(19) United States
(12) Patent Application Publication
(10) Pub. No.: US 2026/0228412 A1
(43) Pub. Date: Aug. 6, 2026

(54) CONVERSATION-BASED VIRTUAL ASSISTANT

(71) Applicant: Walmart Apollo, LLC, Bentonville, AR (US)

(72) Inventors: Komal Arvind Dhuri, San Jose, CA (US); Kanyao Han, Sunnyvale, CA (US); Arpit Sharma, Santa Clara, CA (US); Yushang Lai, Sunnyvale, CA (US); Aditya Choudhary, San Jose, CA (US); Shantanu Aggarwal, Merced, CA (US)

(21) Appl. No.: 19/042,913

(22) Filed: Jan. 31, 2025

(51) Int. Cl. G06F 40/103; G06F 40/186

(52) U.S. Cl. CPC G06F 40/103; G06F 40/186

(57) ABSTRACT

Examples may be related to developing a conversation-based virtual assistant. An example may involve: obtaining, from a user, a query selecting one or more items from at least one list of items; determining context information associated with the at least one list of items; obtaining at least one template including a position reference placeholder; generating at least one prompt, based at least in part, by replacing the position reference placeholder with a plurality of position reference terms such that each position reference term corresponds to a different manner of referring to an item position; training a natural language model by using the at least one prompt; inputting the query and the context information to the trained natural language model to identify the one or more items selected by the query and generate a response referring to the identified one or more items; and presenting the response to the user.

### BACKGROUND

Conversational agents, e.g. chatbots, have become popular in various industry sectors to enhance service processes and reduce costs associated with human resource. For example, chatbots can be used for shopping assistance, customer service and other tasks in the retail industry.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for providing a conversation-based virtual assistant, in accordance with some embodiments;

FIG. 2 is a block diagram of a decision assistance computing device, in accordance with some embodiments;

FIG. 3 is a block diagram illustrating various portions of a system for providing a conversation-based virtual assistant, in accordance with some embodiments;

FIG. 4 illustrates an example architecture of a system for providing a conversation-based virtual assistant, in accordance with some embodiments;

FIG. 5 illustrates an example user interface showing a conversation between a user and a conversational agent, in accordance with some embodiments;

FIG. 6A and FIG. 6B illustrate an example process for generating answers to train a natural language model, in accordance with some embodiments;

FIG. 7A, FIG. 7B and FIG. 7C illustrate an example prompt template for generating prompts to train a natural language model, in accordance with some embodiments;

FIG. 8 shows a flowchart illustrating an example method for generating and presenting a response to a query, in accordance with some embodiments;

FIG. 9 shows a flowchart illustrating an example method performed by a natural language model, in accordance with some embodiments;

FIG. 10 shows a flowchart illustrating an example method for generating a response using a natural language model, in accordance with some embodiments;

FIG. 11 shows a flowchart illustrating an example method for training a natural language model, in accordance with some embodiments;

FIG. 12 shows a flowchart illustrating an example method for generating a plurality of prompts to train a natural language model, in accordance with some embodiments;

FIG. 13 shows a flowchart illustrating an example method for generating a plurality of questions to train a natural language model, in accordance with some embodiments;

FIG. 14 shows a flowchart illustrating an example method for generating a plurality of answers to train a natural language model, in accordance with some embodiments;

FIG. 15 shows a flowchart illustrating an example method for re-training a natural language model, in accordance with some embodiments;

FIG. 16 depicts an example system with a machine-readable medium that includes instructions for generating and presenting a response to a query, in accordance with some embodiments.

### DETAILED DESCRIPTION

In some embodiments, systems and methods are described herein for developing and applying a conversation-based virtual assistant. The conversation-based virtual assistant may be implemented on a computer, a server, or any hardware device to have a conversation with a user, to assist the user to make a choice from multiple options easily and efficiently.

In some examples, when a user is provided with multiple recommended items, the virtual assistant may establish a conversation with the user such that the user can easily compare items, refine product recommendations, and/or evaluate individual products, without a need to navigate between multiple item webpages for different items. In some examples, the virtual assistant can answer item-related questions based on item context information to assist users in making purchase decisions or simplifying a product search process.

In some embodiments, the virtual assistant can utilize a machine learning model, e.g. a natural language model, to identify and differentiate information related to different items in a large context and generate a coherent, concise and accurate answer to a user query. The generated answer may have an appropriate language style that is more relevant to an e-commerce context, e.g. by referring to each item with a corresponding item name, while the item may be referred to by the user query using: a position, an abbreviated item name, a unique item identifier including price, brand or rating displayed together with the item to the user.

In some embodiments, the machine learning model is developed by a disclosed system to generate responses that can clearly refer to relevant items to avoid confusion, particularly when a user mentions multiple items in a single query. In some examples, the system can automatically generate a synthetic training dataset including many question and answer pairs using one or more large language models, based on prompt engineering with instructions, and applying data augmentation through item information replacement. In some embodiments, the system can employ a multi-step, multi-branch approach to train the machine learning model using the synthetic training dataset with prompts, to ensure high-quality question-answer pairs.

In some embodiments, the system may generate the prompts by replacing each placeholder in at least one template with a corresponding term. In some examples, a position reference placeholder may be replaced with a plurality of position reference terms such that each position reference term corresponds to a different manner of referring to an item position. In some examples, an unanswerable token placeholder may be replaced with a predetermined token, a keyword, or an answer template, when the model cannot answer a user query based on provided context information. This can help reducing the chance for the model to fabricate incorrect or misleading answers to questions that cannot be answered by the provided context.

In some embodiments, the system may fine-tune the model based on filtered question and answer pairs along with instructions and special tokens to help the model to identify relevant context and answer questions, to avoid fabricated information, conflicting sources, or inappropriate language styles. In some examples, a prompt template may include one or more separator tokens to separate information for different items, which enables the model to focus on relevant context for better context identification. The fine-tune model can effectively handle context identification and answer generation at the same time, without a need for an additional retrieval model. In some embodiments, the system does not rely on extensive, time-consuming human annotation or require training models on large-scale datasets, which provides a cost-effective solution for building context-based decision assistants using lightweight language models.

In some embodiments, one or more filtering and/or review processes may be implemented at various stages to identify and/or prevent generation of undesirable content by the natural language model or any other model. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In various embodiments, a system including a processor and a non-transitory memory storing instructions is disclosed. The instructions, when executed, cause the processor to: provide at least one list of items to a user; obtain, from the user, a query selecting one or more items from the at least one list; determine context information associated with the at least one list of items; obtain at least one template that includes a position reference placeholder; generate at least one prompt, based at least in part, by replacing the position reference placeholder with a plurality of position reference terms such that each position reference term corresponds to a different manner of referring to an item position; train a natural language model by using the at least one prompt; input the query and the context information to the trained natural language model to identify the one or more items selected by the query and generate a response referring to the identified one or more items; and present the response to the user via a user interface.

In various embodiments, a computer-implemented method is disclosed. The computer-implemented method includes: providing at least one list of items to a user; obtaining, from the user, a query selecting one or more items from the at least one list; determining context information associated with the at least one list of items; obtaining at least one template that includes a position reference placeholder; generating at least one prompt, based at least in part, by replacing the position reference placeholder with a plurality of position reference terms such that each position reference term corresponds to a different manner of referring to an item position; training a natural language model by using the at least one prompt; inputting the query and the context information to the trained natural language model to identify the one or more items selected by the query and generate a response referring to the identified one or more items; and presenting the response to the user via a user interface.

In various embodiments, a non-transitory computer readable medium having instructions stored thereon is disclosed. The instructions, when executed by at least one processor, cause at least one device to perform operations including: providing at least one list of items to a user; obtaining, from the user, a query selecting one or more items from the at least one list; determining context information associated with the at least one list of items; obtaining at least one template that includes a position reference placeholder; generating at least one prompt, based at least in part, by replacing the position reference placeholder with a plurality of position reference terms such that each position reference term corresponds to a different manner of referring to an item position; training a natural language model by using the at least one prompt; inputting the query and the context information to the trained natural language model to identify the one or more items selected by the query and generate a response referring to the identified one or more items; and presenting the response to the user via a user interface.

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

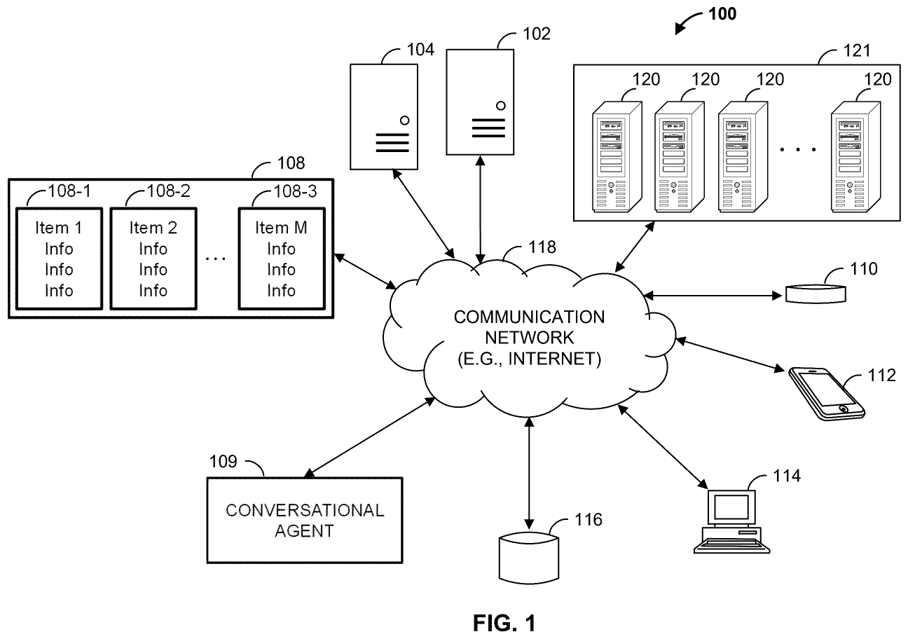

Turning to the drawings, FIG. 1 is a network environment 100 configured for providing a conversation-based virtual assistant, in accordance with some embodiments. The network environment 100 includes a plurality of devices or systems that can communicate over one or more network channels, illustrated as a network cloud 118. For example, in various embodiments, the network environment 100 can include, but not limited to, a decision assistance computing device 102, a server 104 (e.g., a web server or an application server), a cloud-based engine 121 including one or more processing devices 120, a conversational agent 109, a database 116, and one or more user computing devices 110, 112, 114 operatively coupled over the network 118. The decision assistance computing device 102, the server 104, the conversational agent 109, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the decision assistance computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the decision assistance computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or applications providing one or more products or services. In some examples, the decision assistance computing device 102, the processing devices 120, the conversational agent 109 and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The conversational agent 109 may be operably coupled to the communication network 118. In some examples, the conversational agent 109 may be a chatbot owned or hosted by a retailer. At the same time, the retailer may also include other conversational agents, each of which can communicate independently with users and customers of the retailer.

The conversational agent 109 can communicate with the decision assistance computing device 102 over the communication network 118. The conversational agent 109 may send data to, and receive data from, the decision assistance computing device 102. For example, the conversational agent 109 may transmit data related to a conversation with a user to the decision assistance computing device 102.

Although FIG. 1 illustrates three user computing devices 110, 112, 114, the network environment 100 can include any number of user computing devices 110, 112, 114. Similarly, the network environment 100 can include any number of the decision assistance computing devices 102, the processing devices 120, the conversational agents 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the decision assistance computing device 102 over the communication network 118. The website may also enable the operator to add one or more of the items to an online shopping cart, and enable the customer to perform a “checkout” of the shopping cart to purchase the items. In some examples, the server 104 transmits purchase data identifying items the customer has purchased from the website to the decision assistance computing device 102.

In some examples, the decision assistance computing device 102 may receive a query from the conversational agent 109. The query may be sent standalone, together with, or embedded in chat related data associated with a chat or conversation between the conversational agent 109 and a user. The query may be triggered by a question or query submitted by the user via a user interface. The query may select or refer to one or more items in a recommendation list 108, which includes recommended items, e.g. item 1 108-1, item 2 108-2 . . . item M 108-3, presented to the user. For example, the user may ask for a comparison between item 1 108-1 and item 2 108-2, or ask about a specific feature of item 1 108-1. The question may refer to an item using a position, an order, a name or a unique feature of the item. The recommendation list 108 may be provided to the user by the conversational agent 109 or the server 104, e.g. in a search results page or item page displayed to the user.

In some embodiments, the decision assistance computing device 102 may determine context information associated with the recommendation list 108, and input the query and the context information to a natural language model to identify the one or more items selected by the query and generate a response referring to the identified one or more items. The response may be presented to the user by the conversational agent 109 via a user interface. In some examples, the natural language model may be trained, based at least in part, by: obtaining at least one template that includes a position reference placeholder; generating at least one prompt based at least in part by replacing the position reference placeholder with a plurality of position reference terms such that each position reference term corresponds to a different manner of referring to an item position; and training the natural language model by using the at least one prompt.

In some embodiments, the decision assistance computing device 102 is further operable to communicate with the database 116 over the communication network 118. For example, the decision assistance computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the decision assistance computing device 102, in some examples, the database 116 can be a local storage device, such as a hard drive, a non-volatile memory, or a USB stick. For example, the decision assistance computing device 102 may store online purchase data received from the server 104 in the database 116. The decision assistance computing device 102 may receive chat related data from the conversational agent 109 and store them in the database 116. The decision assistance computing device 102 may also receive from the server 104 user session data identifying events associated with browsing sessions, and may store the user session data in the database 116. The decision assistance computing device 102 may also generate a response to a query received from the conversational agent 109, and may store the response in the database 116.

In some examples, the decision assistance computing device 102 generates and/or updates different models (e.g., machine learning models, deep learning models, statistical models, algorithms, etc.) for providing a conversation-based virtual assistant. In some examples, the conversation-based virtual assistant may include the conversational agent 109 as a front end system, and include the decision assistance computing device 102 as a back end system. The decision assistance computing device 102 may generate training data for the models based on data including but not limited to: item metadata, user metadata, historical user behavior data, historical chat data, historical user query data, and user feedback data. The decision assistance computing device 102 trains the models based on their corresponding training data, and stores the models in a database, such as in the database 116 (e.g., a cloud storage). The models, when executed by the decision assistance computing device 102, enable the decision assistance computing device 102 to generate responses for the conversation-based virtual assistant.

In some examples, the decision assistance computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the decision assistance computing device 102 may generate responses for the conversation-based virtual assistant.

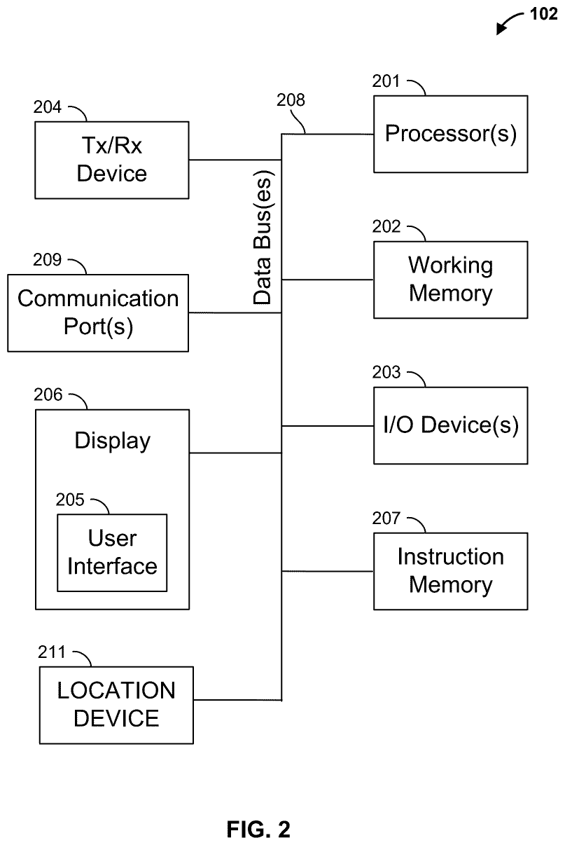

FIG. 2 illustrates a block diagram of a webpage layout optimization device, e.g. the decision assistance computing device 102 of FIG. 1, in accordance with some embodiments. In some embodiments, each of the decision assistance computing device 102, the server 104, the conversational agent 109, the multiple user computing devices 110, 112, 114, and the one or more processing devices 120 in FIG. 1 may include the features shown in FIG. 2. Although FIG. 2 is described with respect to certain components shown therein, it will be appreciated that the elements of the webpage layout optimization device 102 can be combined, omitted, and/or replicated. In addition, it will be appreciated that additional elements other than those illustrated in FIG. 2 can be added to the webpage layout optimization device 102.

As shown in FIG. 2, the webpage layout optimization device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 enable communication among the various components. The data buses 208 can include wired, or wireless, communication channels.

The one or more processors 201 can include any processing circuitry operable to control operations of the webpage layout optimization device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the webpage layout optimization device 102 can include a single memory unit to operate as both instruction memory and working memory. Further, although embodiments are discussed herein including non-volatile memory, it will be appreciated that the webpage layout optimization device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that enables data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 enable communication with a network, such as the communication network 118 of FIG. 1. For example, if the communication network 118 of FIG. 1 is a cellular network, the transceiver 204 enables communications with the cellular network. In some embodiments, the transceiver 204 is selected based on the type of the communication network 118 the webpage layout optimization device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the webpage layout optimization device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 enables the programming of executable instructions in the instruction memory 207. In some embodiments, the communication port(s) 209 enables the transfer (e.g., uploading or downloading) of data, such as machine learning model training data.

In some embodiments, the communication port(s) 209 may couple the webpage layout optimization device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the webpage layout optimization device 102 and/or the server 104. For example, the user interface 205 can be a user interface for an application of a network environment operator that enables a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the webpage layout optimization device 102 may determine a local geographical area (e.g., town, city, state, etc.) of its position.

In some embodiments, the webpage layout optimization device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

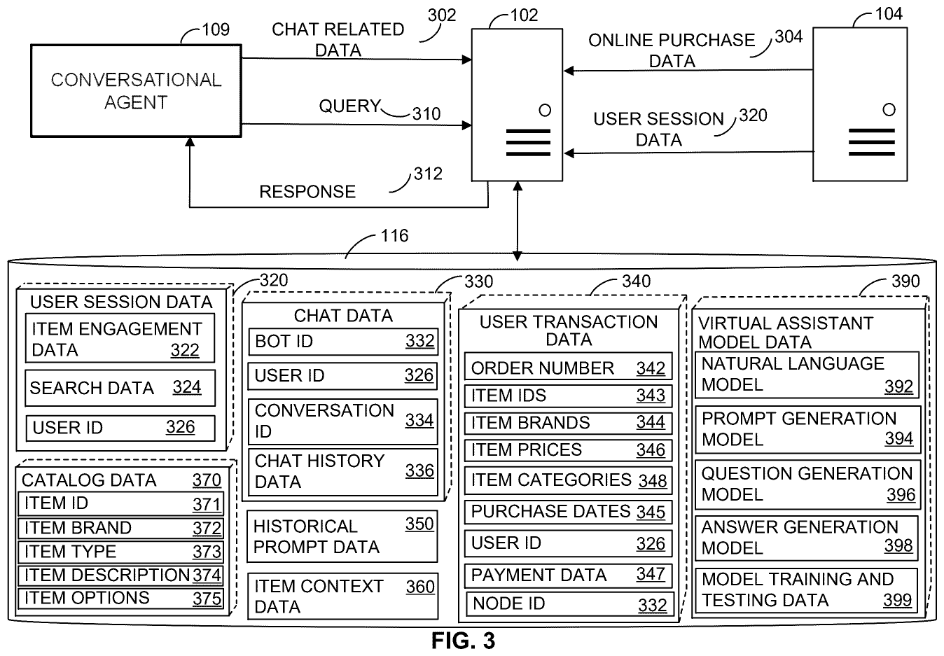

FIG. 3 is a block diagram illustrating various portions of a system for providing a conversation-based virtual assistant, e.g. the system shown in the network environment 100 of FIG. 1, in accordance with some embodiments. As indicated in FIG. 3, the decision assistance computing device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for providing a conversation-based virtual assistant.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The decision assistance computing device 102 may also receive online purchase data 304 from the server 104, which identifies and characterizes one or more online purchases, such as purchases made by the user and other users via a retailer's website hosted by the server 104. The decision assistance computing device 102 may parse the online purchase data 304 to generate user transaction data 340. In some examples, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping-from store associated with the corresponding online purchase.

The decision assistance computing device 102 may also receive chat related data 302 from the conversational agent 109 (and other conversational agents or chatbots), which identifies and characterizes each chat or conversation between the conversational agent 109 and a user. The decision assistance computing device 102 may parse the chat related data 302 to generate chat data 330 stored in the database 116. In some examples, the chat data 330 may include, for each chat or conversation, one or more of: a bot ID 332 (e.g. the bot ID of the conversational agent 109) of a chatbot involving in the conversation, the user ID 326 of a user involving in the conversation, a conversation ID 334 identifying the conversation or a session of the conversation, and chat history data 336 identifying historical content of the current conversation or previous conversations with the same user of the current conversation.

In some embodiments, the conversational agent 109 and the server 104 are associated with each other such that the online purchase data 304, the user session data 320 and the chat related data 302 all come from a same server cluster or datacenter.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some examples, the database 116 may also store historical prompt data 350 identifying historical prompts used for training a natural language model. In some examples, the database 116 may also store item context data 360 identifying context data of items, e.g. various item features in the catalog data 370 that are related to a recommendation list presented to a user or related to a conversation with a user.

In some examples, the decision assistance computing device 102 receives a query 310 from the conversational agent 109. The query 310 may be generated based on a conversation between the conversational agent 109 and a user. In some examples, the query 310 may be a question submitted by the user during the conversation and forwarded by the conversational agent 109 to the decision assistance computing device 102. In some examples, the query 310 may be generated based on a request submitted by the user during the conversation. For example, the user may have been provided a list of recommended items by the server 104 or the conversational agent 109 based on: a search query submitted by the user; an anchor item selected, clicked, added to cart or ordered by the user; or any other interaction performed by the user with a website associated with the server 104 or the conversational agent 109. The conversation between the conversational agent 109 and a user may be established before or after the list of recommended items is presented to the user. If the list of recommended items is presented to the user by the server 104, the server 104 may send context information about the list of recommended items to the conversational agent 109 to help the conversational agent 109 understanding the user's request or question regarding the list of recommended items.

In some examples, the query 310 may refer to one or more items selected from the list of recommended items. For example, the user may ask about a specific feature or parameter of one item in the list of recommended items, or ask about a piece of information regarding each individual item of two or more items in the list, or ask for a comparison of a same parameter of multiple items in the list.

After receiving the query 310, the decision assistance computing device 102 may determine context information associated with the list of recommended items. After generating the list of recommended items, the server 104 or the conversational agent 109 may store context information about the list of recommended items into the database 116, e.g. in the item context data 360. The decision assistance computing device 102 can obtain the context information associated with the list of recommended items from the database 116, e.g. from the item context data 360, or directly from the server 104 or the conversational agent 109.

The decision assistance computing device 102 may input the query 310 and the context information to a natural language model to identify the one or more items selected by the query 310 and generate a response 312 referring to the identified one or more items. Because the query 310 may be a question referring or selecting the one or more items in various manners, e.g. by numerical terms like “1,” “2,” ordinal terms like “second,” “last,” or directional terms like “left,” “right,” “leftmost,” etc., it is not straightforward to identify the one or more items easily.

In some embodiments, the natural language model can be trained to identify the one or more items and generate the response 312 at the same time or in one step without any further input or human intervention. In some examples, the natural language model may be trained, based at least in part, by: obtaining at least one template that includes a position reference placeholder; generating at least one prompt, based at least in part, by replacing the position reference placeholder with a plurality of position reference terms such that each position reference term corresponds to a different manner of referring to an item position; and training the natural language model by using the at least one prompt. After generating the response 312, the decision assistance computing device 102 may transmit the response 312 to the conversational agent 109 for presenting the response 312 to the user via a user interface, e.g. the user interface showing the conversation between the conversational agent 109 and the user.

The database 116 may also store virtual assistant model data 390 identifying and characterizing one or more models and related data for providing a conversation-based virtual assistant. For example, the virtual assistant model data 390 may include: a natural language model 392, a prompt generation model 394, a question generation model 396, an answer generation model 398 and model training and testing data 399. In various embodiments, the virtual assistant model data 390 may include any number of the natural language models 392, the prompt generation models 394, the question generation models 396, and the answer generation models 398.

The natural language model 392 in some examples can be used to identify one or more items referred to by the query 310, and corresponding context data of the one or more items. In some examples, each of the one or more items may be referred to by the query 310 using at least one of: a position of the item in the list of recommended items, an abbreviated item name of the item, a unique item identifier including price, brand or rating displayed together with the item in the list. For example, the natural language model 392 may be used to determine a query type of the query 310. The query type may include one of: a comparison of multiple items, a query involving a single item, or a query involving each of multiple items. Based on the query type, the natural language model 392 may identify the one or more items, and determine context data associated with the one or more items, e.g. from the item context data 360. In some embodiments, the natural language models 392 may generate the response 312 based on: the query 310, the context data associated with the one or more items, and a conversation history between the user and the conversational agent 109.

The prompt generation model 394 in some examples may be used to generate prompts for a natural language model, e.g. the natural language models 392. In some examples, during an inference stage of the natural language model, the prompt generation models 394 can be used to generate a prompt including: the query 310, the context information, the conversation history and an instruction; and input the prompt into the natural language model to generate the response 312. In some examples, the query 310 may be in form of a question regarding the one or more items; and the response 312 may include: (1) an answer to the question and (2) at least one item indication indicating at least one item based on which the answer is generated. The answer may refer to each of the at least one item using a corresponding item name.

In some examples, during a training stage of the natural language model, the prompt generation models 394 may be used to generate a plurality of prompts including context information of a plurality of items. For example, the prompt generation models 394 may first generate a plurality of prompt templates. Each of the plurality of prompt templates may comprise a position reference placeholder and at least one of: an assigned role of the natural language model, a task instruction, an unanswerable token placeholder, a guideline for a response generation, an expected output format for the response generation, or one or more safety rules. The prompt generation models 394 may replace each position reference placeholder in the plurality of prompt templates with a plurality of position reference terms corresponding to a plurality of manners of referring to an item position. The plurality of position reference terms may comprise at least: a numerical term, an ordinal term and a directional term. The prompt generation models 394 may also replace each unanswerable token placeholder in the plurality of prompt templates with one of: a predetermined token, a keyword, or an answer template. The prompt generation models 394 may also add at least one separator token to separate information for different items in each prompt template. With the replaced placeholders and the added at least one separator token, the prompt generation models 394 can generate the plurality of prompts based on the plurality of prompt templates for training the natural language model.

The question generation model 396 in this example can be used to generate a plurality of questions for generating a training dataset to train a natural language model, e.g. the natural language models 392. For example, the question generation models 396 can generate a plurality of question templates based on the plurality of prompts generated by the prompt generation models 394. The plurality of prompts may be governed by at least one rule that restricts types of questions to be generated for the training dataset by the question generation models 396. Each of the plurality of question templates may comprise at least one feature placeholder for product related features including at least: product information, seller information, and transaction-related information. In some examples, the question generation models 396 may randomly pair each of the plurality of question templates with at least one product in a product catalog, e.g. based on the catalog data 370; and replace each feature placeholder in the plurality of question templates with one or more features of the at least one product. The question generation models 396 can generate the plurality of questions based on the plurality of question templates with the replaced feature placeholders.

In some examples, the answer generation model 398 can be used to generate answers for training a natural language model, e.g. the natural language models 392. During a training stage of the natural language model, the answer generation models 398 may be used to generate a plurality of answers separately from the plurality of questions generated by the question generation models 396. For example, the answer generation models 398 can classify the plurality of questions generated by the question generation models 396 into a plurality of question categories including at least: a general question category including general questions regarding each individual item separately, and a comparison question category including comparison questions each regarding a comparison of multiple items. Based on the plurality of question categories and the expected output format for answers to be generated for the training dataset, the answer generation models 398 may generate a plurality of answer templates. For each general question in the general question category, the answer generation models 398 can determine whether the general question refers to one item or multiple items. In accordance with a determination that the general question refers to a single item, the answer generation models 398 may generate an answer to the general question based on context data associated with the single item. In accordance with a determination that the general question refers to a plurality of items, the answer generation models 398 may generate a plurality of answers, each of which is generated based on context data associated with a corresponding one of the plurality of items, and merge the plurality of answers to a single answer to the general question. For each comparison question in the comparison question category, the answer generation models 398 may determine two or more items referred to by the comparison question, obtain combined context data of the two or more items, and generate an answer to the comparison question based on the combined context data.

In some embodiments, one or more of the natural language models 392, the prompt generation models 394, the question generation models 396, and the answer generation models 398 can be implemented as a machine learning model. The model training and testing data 399 may include data utilized for training one or more of the natural language models 392, the prompt generation models 394, the question generation models 396, and the answer generation models 398. In some examples, the model training and testing data 399 may be formed based on: item metadata, user metadata, historical user behavior data, historical chat data, historical user query data, historical and labelled prompt data, and user feedback data, obtained from either real data or synthetic data.

In some embodiments, the decision assistance computing device 102 may assign one or more of the above described operations to a different processing unit or virtual machine hosted by one or more processing devices 120. Further, the decision assistance computing device 102 may obtain the outputs of the these assigned operations from the processing units, and generate the response 312 based on the outputs.

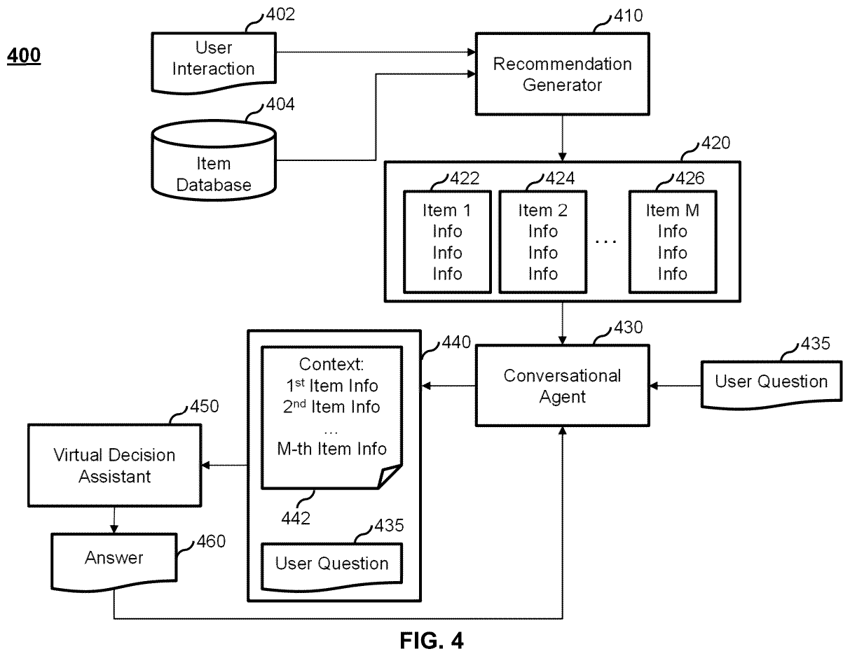

FIG. 4 illustrates an example architecture of a system 400 for providing a conversation-based virtual assistant, in accordance with some embodiments. In some embodiments, the system 400 can be implemented by one or more computing devices, such as the decision assistance computing device 102, the server 104, the conversational agent 109 and/or the cloud-based engine 121 of FIG. 1.

As shown in FIG. 4, the system 400 in this example includes a recommendation generator 410, a conversational agent 430 and a virtual decision assistant 450. In some examples, the recommendation generator 410 may be implemented by the server 104 or the conversational agent 109 in FIG. 1, the conversational agent 430 may be implemented by the conversational agent 109 in FIG. 1, and the virtual decision assistant 450 may be implemented by the decision assistance computing device 102 in FIG. 1.

In some examples, the recommendation generator 410 can provide at least one list of items to a user. For example, the recommendation generator 410 may obtain user interaction data 402 that identifies interactions between the user and a website or application associated with the server 104 or the conversational agent 109. For example, the interaction data 402 may include a search query submitted by the user. Based on the interaction data 402, the recommendation generator 410 may generate and present a recommendation list 420 to the user. The recommendation list 420 may include information of a list of recommended items based on an item database 404, which may be part of the database 116 or a standalone database. For example, based on the search query, the recommendation generator 410 may generate M items (e.g. item 1 422, item 2 424 . . . item M 426) in the recommendation list 420 as search results matching the search query.

In some examples, the recommendation generator 410 can send recommendation related data about the recommendation list 420 to the conversational agent 430. The recommendation related data may comprise at least one of: an item identity of each item in the recommendation list 420, position information of each item in the recommendation list 420, or data displayed together with each item in the recommendation list 420.

In some situations, the conversational agent 430 may establish a conversation with the user who obtains the recommendation list 420. In some situations, the conversational agent 430 may have established a conversation with the user and continue the conversation with the user after the user obtains the recommendation list 420. In any of these situations, the user may submit a user question 435 via a user interface with the conversational agent 430, during the conversation with the conversational agent 430 after the user obtains the recommendation list 420. For example, the user question 435 may ask about one or more items selected from the recommendation list 420.

After obtaining the user question 435 from the user during the conversation, the conversational agent 430 can determine context information 442 associated with the recommendation list 420 based on the recommendation related data received from the recommendation generator 410, to generate a query 440, which may include the user question 435 and the context information 442. In some examples, the context information 442 may include various information about each product item, including e.g. product information (e.g. size, color, battery life, etc.), seller information (e.g. brand, seller name, etc.), and transaction-related information (e.g. item availability, price, shipping policy, pick up or delivery time, return policy, etc.). In some examples, the conversational agent 430 may determine the context information 442, based at least in part, by converting the recommendation related data into a standardized data format that is in accordance with a natural language acceptable by a natural language model associated with the virtual decision assistant 450. The conversational agent 430 may send the query 440, together with a conversation history between the user and the conversational agent 430, to the virtual decision assistant 450 for response generation.

In some examples, the virtual decision assistant 450 can input the query 440 with the context information 442 to the natural language model to identify the one or more items selected or referred to by the query and generate a response referring to the identified one or more items. For example, the response may include an answer 460 to the user question 435.

In some embodiments, the virtual decision assistant 450 may determine a query type of the query 440 or the user question 435, e.g. using the natural language model. The query type may be one of: a comparison of multiple items, a query involving a single item, or a query involving each of multiple items. The virtual decision assistant 450 may use the natural language model to identify the one or more items based on the query type, and determine, from the context information 440, context data associated with the one or more items. The response including the answer 460 may be generated using the natural language model based on: the query 440, the context data associated with the one or more items, and the conversation history between the user and the conversational agent 430.

In some embodiments, the virtual decision assistant 450 may generate the response, based at least in part, by: generating a prompt including: the query 440 with the context information 442, the conversation history and an instruction; and inputting the prompt into the natural language model to generate the response including the answer 460. In some examples, each of the one or more items is referred to by the user question 435 using at least one of: a position of the item in the recommendation list 420, an abbreviated item name of the item, a unique item identifier including price, brand or rating displayed together with the item in the recommendation list 420. In some examples, the response may include both the answer 460 and at least one item indication indicating at least one item based on which the answer 460 is generated. The answer 460 may refer to each of the at least one item using a corresponding item name. The virtual decision assistant 450 may send the response including the answer 460 to the conversational agent 430 in real time, for presenting the response to the user via the user interface showing the conversation.

In some embodiments, during a training stage of the natural language model, the virtual decision assistant 450 may train the natural language model, based at least in part, by: obtaining at least one template that includes a position reference placeholder; generating at least one prompt, based at least in part, by replacing the position reference placeholder with a plurality of position reference terms such that each position reference term corresponds to a different manner of referring to an item position; and training the natural language model by using the at least one prompt.

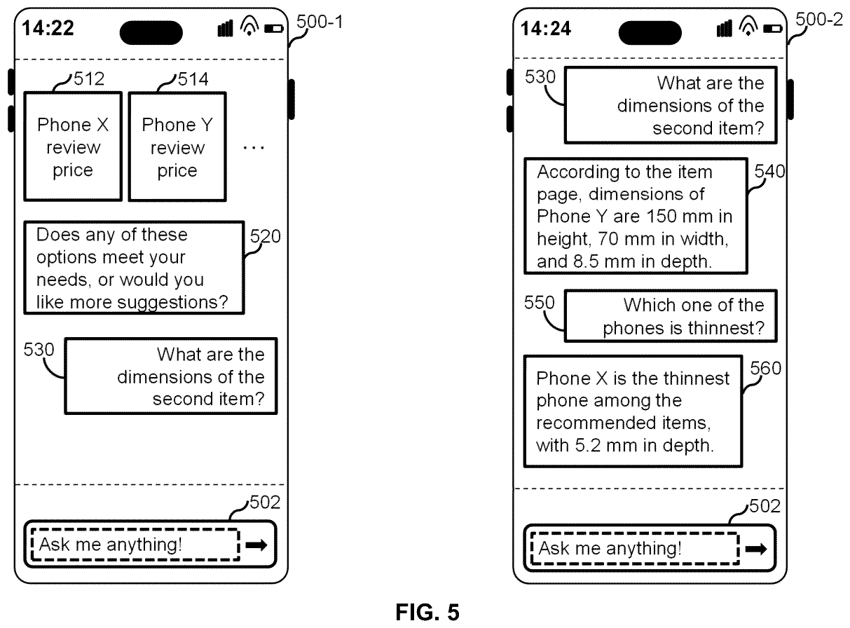

FIG. 5 illustrates an example user interface showing a conversation 500 between a user and a conversational agent, in accordance with some embodiments. The conversation 500 may be referred to as 500-1 in a first time frame of the conversation, and referred to as 500-2 in a second time frame (after the first time frame) of the conversation.

As shown in FIG. 5, the conversation 500-1 in the first time frame may include: a list of recommended options 512, 514, an agent question 520 asked by the conversational agent, and a first user question 530 asked by the user. For example, the list of recommended options 512, 514 may include recommended items, e.g. phone X, phone Y..., displayed to the user in the user interface. Each item may be displayed along with a link to the item's web page with key information segments. In some examples, the list of recommended options 512, 514 may be displayed in a carousal module arranged horizontally in the user interface, while the rest of the conversation including the agent question 520 and the first user question 530 can be displayed below the carousal module. While phone X and phone Y may be shown as the first two options in the carousal module, the user may slide or select to view the other options in the carousal module.

In some examples, the conversational agent may ask the agent question 520 (“Does any of these options meet your needs, or would you like more suggestions?”) automatically after showing the list of recommended options 512, 514 to the user. In response, the user can submit the first user question 530 (“What are the dimensions of the second item?”) via an input field 502 in the user interface.

As shown in FIG. 5, the conversation 500-2 in the second time frame may include: the first user question 530 asked by the user, a first agent answer 540 provided by the conversational agent in response to the first user question 530, a second user question 550 asked by the user, and a second agent answer 560 provided by the conversational agent in response to the second user question 550. In some embodiments, because the first user question 530 refers to the “second item,” the conversational agent may identify phone Y 514 as the “second item” from the list of recommended options, e.g. using a trained natural language model. Based on this identification, the conversational agent can generate the first agent answer 540 (“According to the item page, dimensions of Phone Y are 150 mm in height, 70 mm in width, and 8.5 mm in depth.”) based on the first user question 530 and context information regarding the identified phone Y, e.g. using the trained natural language model.

In some examples, the conversational agent may identify the second user question 550 (“Which one of the phones is thinnest?”) as a comparison question regarding all phones in the list of recommended options, e.g. based on the trained natural language model. As such, the conversational agent can generate the second agent answer 560 (“Phone X is the thinnest phone among the recommended items, with 5.2 mm in depth.”) based on the second user question 550 and context information regarding all phones in the list of recommended options, e.g. using the trained natural language model.

In some examples, if there is no input from the user via the input field 502 after a certain time period since the second agent answer 560 is presented, the conversational agent may ask the user to confirm whether the second agent answer 560 reflects a correct understanding of the second user question 550. If the understanding is incorrect, the conversational agent may ask whether the item(s) identified or referred to in the second agent answer 560 are correct, or whether the second agent answer 560 does not satisfy. The feedback received from the user may be used as future training data for training or re-training the natural language model.

In some embodiments, a natural language model utilized by the conversational agent in FIG. 5 or the virtual decision assistant 450 in FIG. 4, may be trained, based at least in part, by: generating a plurality of prompts including context information of a plurality of items; generating a plurality of questions; generating a plurality of answers separately from the plurality of questions; generating a training dataset based on the plurality of prompts, the plurality of questions and the plurality of answers; and training the natural language model using the training dataset.

In some examples, the plurality of questions may be generated, based at least in part, by generating a plurality of question templates based on the plurality of prompts governed by at least one rule that restricts types of questions to be generated for the training dataset. Each of the plurality of question templates may comprise one or more position reference placeholders for item positions used for referring to corresponding one or more items. Each of the plurality of question templates may comprise at least one feature placeholder for product related features including at least: product information (e.g. size, color, battery life, etc.), seller information (e.g. brand, seller name, etc.), and transaction-related information (e.g. item availability, price, shipping policy, pick up or delivery time, return policy, etc.). Some example question templates may include: “What other colors are available for <pos> and <pos> TV?” and “What other colors are available for the TV with a price of <price>?”

In some examples, a user may use ambiguous references like “the product,” such that it is unclear which item is referred to by the user. Such examples may be included in the training dataset as well. For example, the position or attribute placeholders in a question template may be replaced with ambiguous references, where a corresponding answer generated by the natural language model can be a clarification question asking which item the user is referring to.

In some examples, the system may randomly pair each of the plurality of question templates with at least one product in a product catalog, and replace each feature placeholder in the plurality of question templates with one or more features of the at least one product. The plurality of questions may be generated based on the plurality of question templates with the replaced feature placeholders.

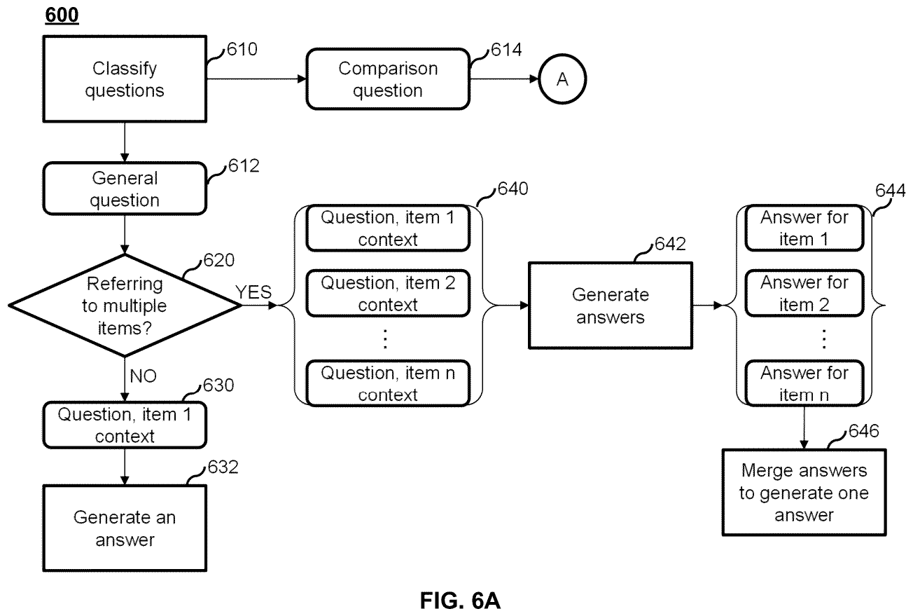

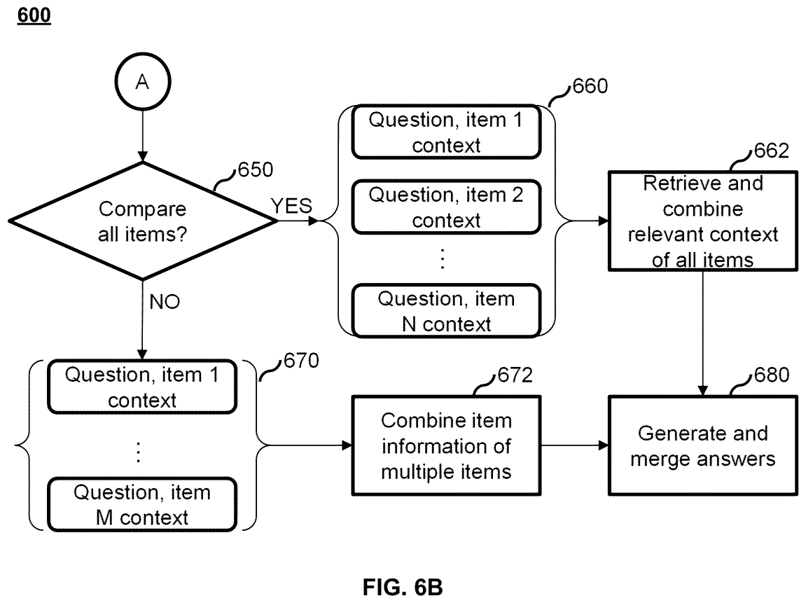

FIG. 6A and FIG. 6B illustrate an example process 600 for generating answers to train a natural language model, in accordance with some embodiments. In some embodiments, the process 600 can be carried out by a system including one or more computing devices, such as the webpage layout optimization device 102 and/or the cloud-based engine 121 of FIG. 1. In some embodiments, generating a list of item positions is unnecessary during the answer generation, as the correct positions have already been determined during the question generation, for training the natural language model.

As shown in FIG. 6A, beginning at operation 610, the plurality of questions may be classified into a plurality of question categories including at least: a general question category including general questions regarding each individual item separately, and a comparison question category including comparison questions each regarding a comparison of multiple items. Some example general questions may include: “What is the brand for first and second coffee maker?”, “Can first and last TV be paired to my home Wi-Fi?” Some example comparison questions may include: “Compare all the TV's”, “Compare bit rate for all the laptops”, “What is the difference between first and last laptop's screen size?”

In some embodiments, for each general question 612 in the general question category, it may be determined at operation 620 that whether the general question 612 refers to multiple items. If so, each of the multiple items may be answered individually. For example, a plurality of queries 640 each including the general question 612 and context data associated with a corresponding one of the multiple items, may be generated. The plurality of queries 640 may be used at operation 642 to generate a plurality of answers 644, each of which is generated in response to a corresponding query for a corresponding item, based on context data associated with the corresponding item. In some embodiments, the answers 644 are generated by inputting the plurality of queries 640 as prompts into a machine learning model (e.g. a natural language model or a large language model), which may or may not be the natural language model to be trained based on the generated answers from the process 600. At operation 646, the plurality of answers 644 are merged to generate a single answer to the general question 412.

In some examples, if it is determined at the operation 620 that the general question 612 refers to a single item, a query 630 including the general question 612 and context data associated with the single item (e.g. item 1), may be generated. The query 630 may be used at operation 632 to generate an answer to the general question 612 based on the context data associated with the single item, e.g. by inputting the query 630 as a prompt into a machine learning model (e.g. a natural language model or a large language model), which may or may not be the natural language model.

In some embodiments, for each comparison question 614 in the comparison question category, it may be determined at operation 650 in FIG. 6B that whether the comparison question 614 refers to a comparison of all items in a recommended list presented to a user. If so, a plurality of queries 660 each including the comparison question 614 and context data associated with a corresponding one of all the items, may be generated. The plurality of queries 660 may be used at operation 662 to retrieve relevant context information for each item (e.g. using a retrieval-augmented generation method) and combine them together, to generate combined relevant context of all items. The combined relevant context may be used at operation 680 to generate and merge answers, to generate a coherent and concise answer to the comparison question 614. For example, the combined relevant context may be used as part of a prompt input into a natural language model or a large language model to generate the answer to the comparison question 614.

In some examples, if it is determined at the operation 650 that the comparison question 614 refers to a comparison of a subset (two or more items) of all items in the recommended list presented to a user, a plurality of queries 670 each including the comparison question 614 and context data associated with a corresponding one of the subset of items, may be generated. The plurality of queries 670 may be used at operation 672 to directly combine all item information of the subset of items, to generate combined item information of the subset of items. The combined item information may be used as part of a prompt input into a natural language model or a large language model at operation 680 to generate and merge answers, to generate a coherent and concise answer to the comparison question 614.

In some embodiments, the answers generated in the process 600 may be generated based on one or more answer templates. The one or more answer templates may be generated based on the plurality of question categories and an expected output format for answers to be generated for a training dataset to be used for training a natural language model, e.g. the natural language model utilized by the conversational agent in FIG. 5 or the virtual decision assistant 450 in FIG. 4. The training dataset including the questions and answers may be automatically generated as discussed above without a need of human labelers or human data generators. In some embodiments, the questions and answers in the training dataset are generated separately.

In some embodiments, during a training stage of the natural language model, all prompts corresponding to different types of questions are trained together. During an inference stage of the natural language model, based on different types of user questions, separate prompts may be triggered to generate corresponding answers.

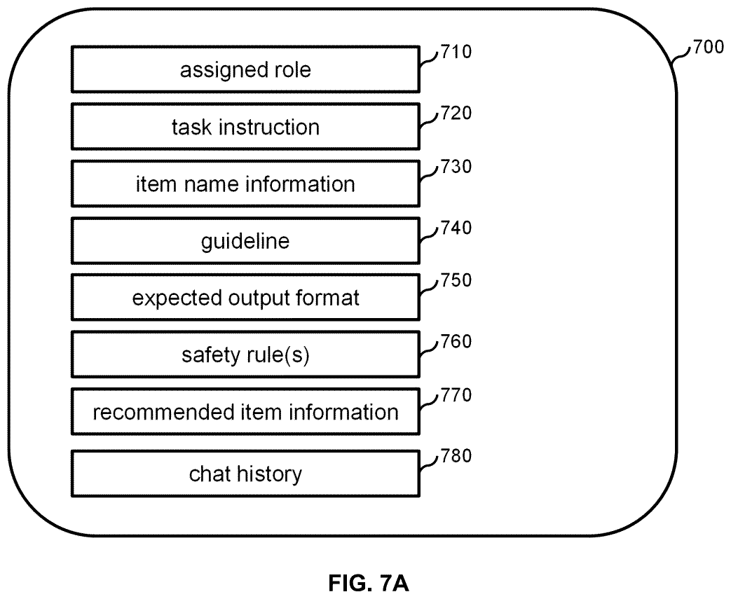

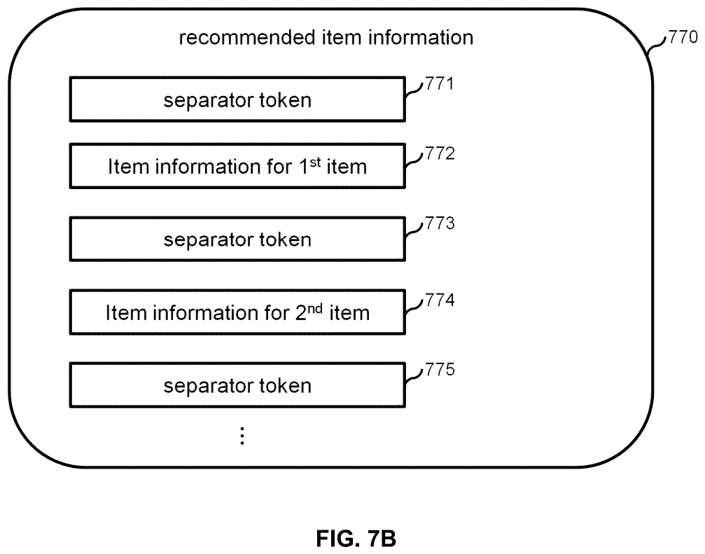

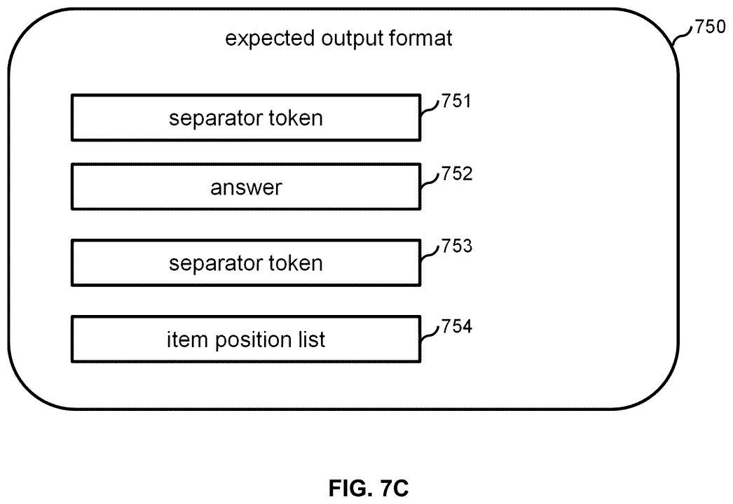

As discussed above, the training dataset may be generated by generating a plurality of prompts. In some embodiments, the plurality of prompts may be generated based on a plurality of prompt templates. FIG. 7A, FIG. 7B and FIG. 7C illustrate an example prompt template 700 for generating prompts to train a natural language model, in accordance with some embodiments. In some embodiments, the natural language model may be the natural language model utilized by the conversational agent in FIG. 5 or the virtual decision assistant 450 in FIG. 4.

As shown in FIG. 7A, the prompt template 700 may include: an assigned role 710 of the natural language model, a task instruction 720, item name information 730 for all items, a guideline 740 for a response generation, an expected output format 750 for the response generation, one or more safety rules 760, recommended item information 770, and a chat history 780. In some embodiments, the prompt template 700 may not include all of the components shown in FIG. 7A for generating prompts.

In some examples, the assigned role 710 may identify a role (e.g. question answering assistant or another virtual assistant) of the natural language model. In some examples, the task instruction 720 may identify an instruction for the task of generating true answers with correct item positions for users'questions, e.g. only using resources being given regarding a list of recommended items. In some embodiments, forcing the natural language model to base its answers merely on the provided information, rather than external knowledge, can avoid potential conflicts or misunderstandings.

In some examples, the item name information 730 may identify information of names of the recommended items in the list. For example, the item name information 730 for each item in the list may include a position reference placeholder and an item name placeholder. In some embodiments, each position reference placeholder in the prompt template 700 may be replaced with a plurality of position reference terms corresponding to a plurality of manners of referring to an item position, to generate the prompts for the training dataset. In some examples, the plurality of position reference terms may comprise at least: a numerical term (e.g. “1,” “2,” etc.), an ordinal term (e.g. “second,” “last,” etc.) and a directional term (e.g. “left,” “right,” “leftmost,” etc.). In some embodiments, each item name placeholder in the prompt template 700 may be replaced with a corresponding real item name to generate the prompts for the training dataset during a training stage of the natural language model. This can help the natural language model to better recognize a variety of positional references potentially used by users.

In some examples, the guideline 740 may be a guideline for generating responses to the users'questions. For example, the guideline 740 may indicate that the natural language model must reply with an unanswerable token placeholder when the answer cannot be found in the provide context information or none of the provided context information is relevant. In some embodiments, each unanswerable token placeholder in the prompt template 700 may be replaced with one of: a predetermined token, a keyword, or an answer template, to generate the prompts for the training dataset during a training stage of the natural language model. In some examples, the same substitute (e.g. token, keyword, or answer template) may be consistently used for unanswerable responses in the training dataset. This can help reducing incorrect answers with fabricated information generated by the natural language model, when a question cannot be answered by the provided context.

In some examples, the expected output format 750 may identify an output format that should be followed by each response generated by the natural language model. In some examples, according to the expected output format 750, each response generated by the natural language model should include both an answer to a user question and a list of item positions that correspond to the items referenced in the question and the answer. In some embodiments, the list of item positions can provide attribution to the specific data based on which the natural language model generates the answer, as the natural language model may pay more attention to item positions it generates and the information it uses from the context section to generate responses.

According to some embodiments, FIG. 7C shows detailed information in the section of the expected output format 750 in the prompt template 700. According to the expected output format 750, each response generated by the natural language model should include both an answer 752 to a user question and an item position list 754 including a list of item positions that correspond to the items referenced in the question and the answer. As shown in FIG. 7C, the expected output format 750 may include some separator tokens 751, 753 to separate information about the answer 752 and the item position list 754.

In some examples, the one or more safety rules 760 may identify some rules the natural language model must follow when generating the responses. The one or more safety rules 760 can avoid generating any racist, offensive or otherwise inappropriate answer by the natural language model. For example, a rule may specify that the natural language model must reply with an unanswerable token placeholder (which may be replaced with a token or keyword during prompt generation and model training) when the natural language model cannot answer. For example, a rule may specify that the answer generated by the natural language model must include a brief name for each item referred to by the corresponding question. Referring to each item using a uniform, clear format like a brief item name (rather than vague terms or positional terms) in every answer can avoid confusion and ensure consistency.

In some examples, the recommended item information 770 may include item information for all recommended items. In some examples, the chat history 780 may include a history of a conversation or chat with the same user by the same or different conversational agents.

According to some embodiments, FIG. 7B shows detailed information in the recommended item information 770 of the prompt template 700. As shown in FIG. 7B, the recommended item information 770 may include separator tokens 771, 773, 775 to separate item information 772, 774 for different recommended items referred to in the prompt template 700. In some examples, the separator tokens may also be added to the natural language model's vocabulary during a training of the natural language model. The separator tokens can help distinguish between different items by marking clear boundaries within the context section of the prompt template 700, thereby reducing errors caused by identifying wrong context for question answering.

In some embodiments, based on one or more prompt templates like the prompt template 700, a plurality of prompts may be generated with the placeholders replaced and the separator token(s) added in the one or more prompt templates. The plurality of prompts can be used to generate the training dataset to train the natural language model discussed above.

In some embodiments, the natural language model may be re-trained, based at least in part, by: generating at least one updated prompt including updated context information of at least one item; and re-training the natural language model using the training dataset and the at least one updated prompt including the updated context information.

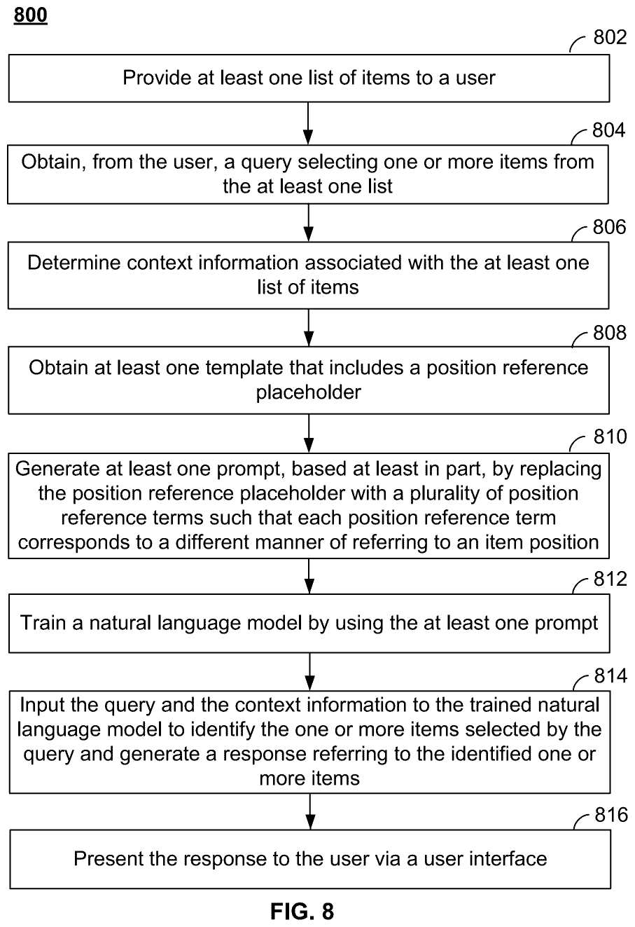

FIG. 8 shows a flowchart illustrating an example method 800 for generating and presenting a response to a query, in accordance with some embodiments. In some embodiments, the method 800 can be carried out by one or more computing devices, such as the decision assistance computing device 102, the server 104, the conversational agent 109, and/or the cloud-based engine 121 of FIG. 1.

As shown in FIG. 8, the method 800 starts from operation 802, where at least one list of items are provided to a user. Then at operation 804, a query selecting one or more items from the at least one list is obtained from the user. At operation 806, context information associated with the at least one list of items is determined. At operation 808, at least one template is obtained, the at least one template including a position reference placeholder. At operation 810, at least one prompt is generated, based at least in part, by replacing the position reference placeholder with a plurality of position reference terms such that each position reference term corresponds to a different manner of referring to an item position. At operation 812, a natural language model is trained by using the at least one prompt. At operation 814, the query and the context information are input to the trained natural language model to identify the one or more items selected by the query and generate a response referring to the identified one or more items. At operation 816, the response is presented to the user via a user interface.

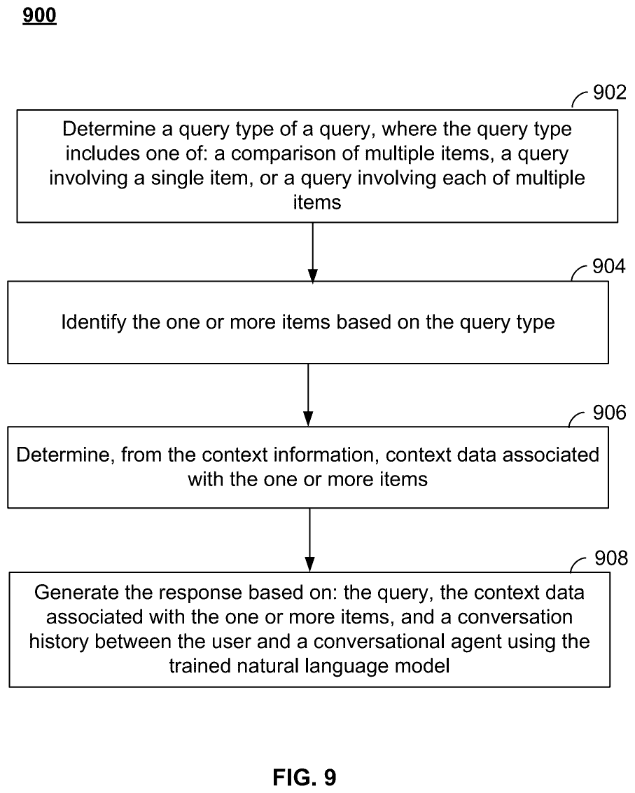

FIG. 9 shows a flowchart illustrating an example method 900 performed by a natural language model, in accordance with some embodiments. In some embodiments, the method 900 can be carried out by a system including one or more computing devices, such as the decision assistance computing device 102, the server 104, the conversational agent 109 and/or the cloud-based engine 121 of FIG. 1.

As shown in FIG. 9, the method 900 starts from operation 902, where a query type of the query is determined. The query type may include one of: a comparison of multiple items, a query involving a single item, or a query involving each of multiple items. Then at operation 904, the one or more items are identified based on the query type. At operation 906, context data associated with the one or more items are determined from the context information. At operation 908, the response is generated based on: the query, the context data associated with the one or more items, and a conversation history between the user and a conversational agent using the trained natural language model.

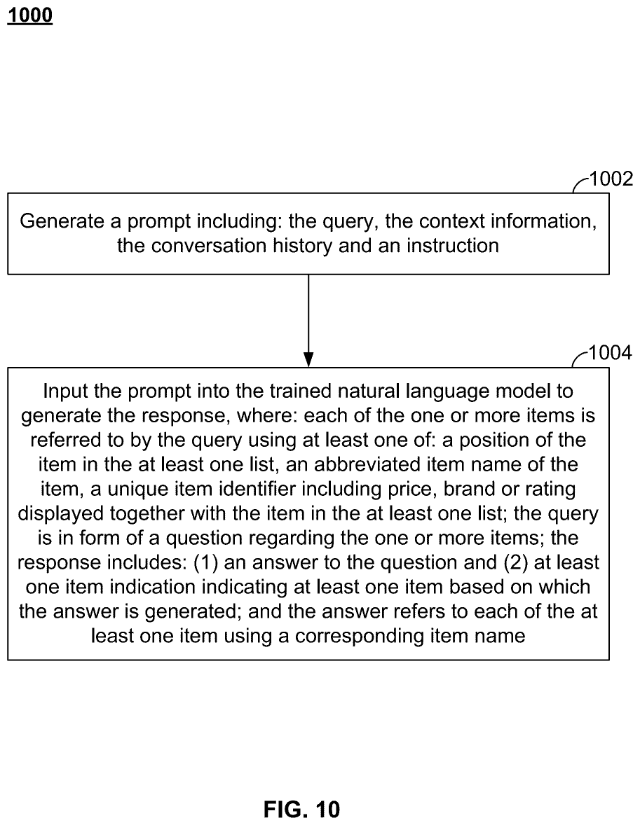

FIG. 10 shows a flowchart illustrating an example method 1000 for generating a response using a natural language model, in accordance with some embodiments. In some embodiments, the method 1000 can be performed as part of the operation 814 of the example method 800 in FIG. 8. In some embodiments, the process 1000 can be carried out by a system including one or more computing devices, such as the decision assistance computing device 102, the server 104, the conversational agent 109 and/or the cloud-based engine 121 of FIG. 1. As shown in FIG. 10, the method 1000 starts from operation 1002, where a prompt is generated to include: the query, the context information, the conversation history and an instruction. Then at operation 1004, the prompt is input into the trained natural language model to generate the response. Each of the one or more items may be referred to by the query using at least one of: a position of the item in the at least one list, an abbreviated item name of the item, a unique item identifier including price, brand or rating displayed together with the item in the at least one list. The query can be in form of a question regarding the one or more items. The response may include: (1) an answer to the question and (2) at least one item indication indicating at least one item based on which the answer is generated. The answer may refer to each of the at least one item using a corresponding item name.

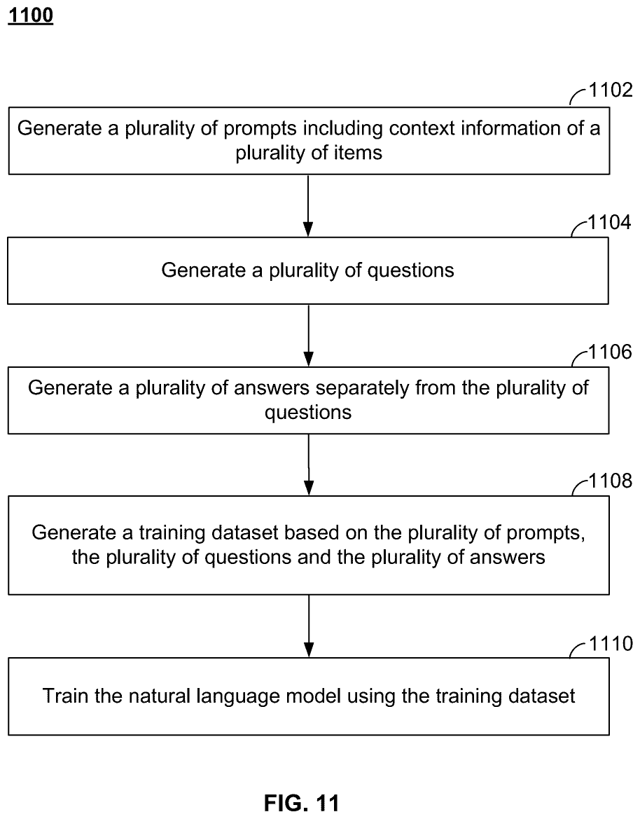

FIG. 11 shows a flowchart illustrating an example method 1100 for training a natural language model, in accordance with some embodiments. In some embodiments, the method 1100 can be performed as part of the operation 812 of the example method 800 in FIG. 8. In some embodiments, the process 1100 can be carried out by a system including one or more computing devices, such as the decision assistance computing device 102, the server 104, the conversational agent 109 and/or the cloud-based engine 121 of FIG. 1.

As shown in FIG. 11, the method 1100 starts from operation 1102, where a plurality of prompts are generated to include context information of a plurality of items. Then at operation 1104, a plurality of questions are generated. At operation 1106, a plurality of answers are generated separately from the plurality of questions. Then at operation 1108, a training dataset is generated based on the plurality of prompts, the plurality of questions and the plurality of answers. At operation 1110, the natural language model is trained using the training dataset.

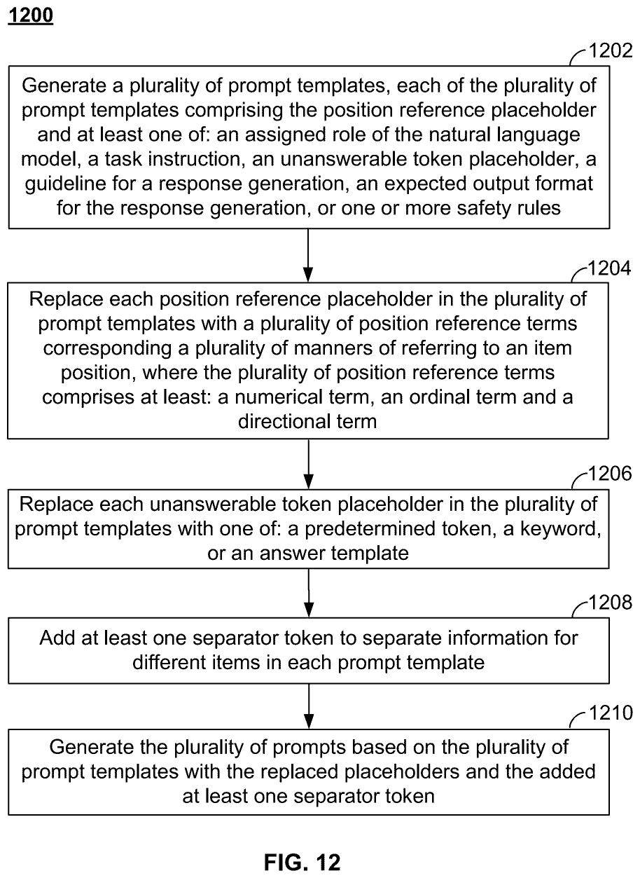

FIG. 12 shows a flowchart illustrating an example method 1200 for generating a plurality of prompts to train a natural language model, in accordance with some embodiments. In some embodiments, the method 1200 can be performed as part of the operation 1102 of the example method 1100 in FIG. 11. In some embodiments, the method 1200 can be carried out by a system including one or more computing devices, such as the decision assistance computing device 102, the server 104, the conversational agent 109 and/or the cloud-based engine 121 of FIG. 1.

As shown in FIG. 12, the method 1200 starts from operation 1202, where a plurality of prompt templates are generated. Each of the plurality of prompt templates may comprise the position reference placeholder and at least one of: an assigned role of the natural language model, a task instruction, an unanswerable token placeholder, a guideline for a response generation, an expected output format for the response generation, or one or more safety rules. Then at operation 1204, each position reference placeholder in the plurality of prompt templates is replaced with a plurality of position reference terms corresponding to a plurality of manners of referring to an item position. The plurality of position reference terms comprise at least: a numerical term, an ordinal term and a directional term. At operation 1206, each unanswerable token placeholder in the plurality of prompt templates is replaced with one of: a predetermined token, a keyword, or an answer template. At operation 1208, at least one separator token is added to separate information for different items in each prompt template. At operation 1210, the plurality of prompts are generated based on the plurality of prompt templates with the replaced placeholders and the added at least one separator token.

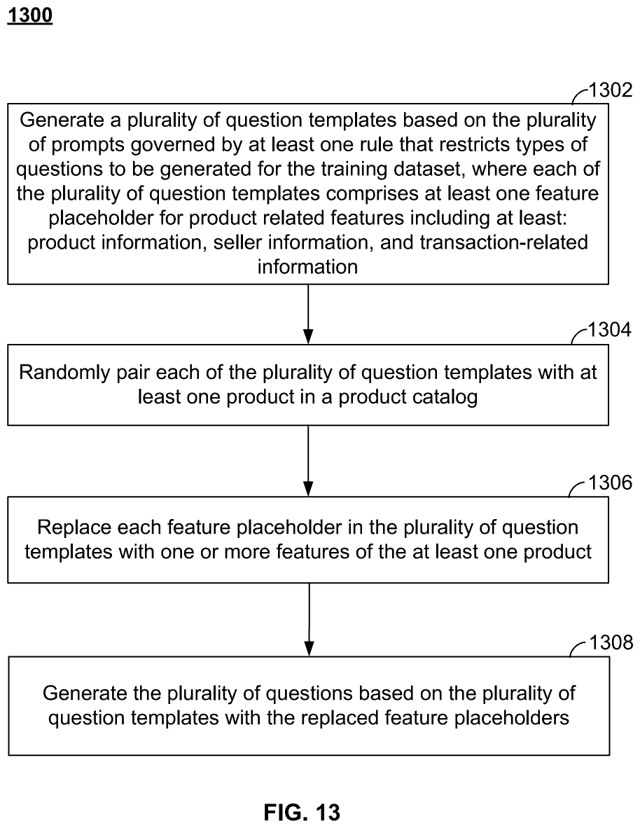

FIG. 13 shows a flowchart illustrating an example method 1300 for generating a plurality of questions to train a natural language model, in accordance with some embodiments. In some embodiments, the method 1300 can be performed as part of the operation 1104 of the example method 1100 in FIG. 11. In some embodiments, the method 1300 can be carried out by a system including one or more computing devices, such as the decision assistance computing device 102, the server 104, the conversational agent 109 and/or the cloud-based engine 121 of FIG. 1.

As shown in FIG. 13, the method 1300 starts from operation 1302, where a plurality of question templates are generated based on the plurality of prompts governed by at least one rule that restricts types of questions to be generated for the training dataset. Each of the plurality of question templates may comprise at least one feature placeholder for product related features including at least: product information, seller information, and transaction-related information. Then at operation 1304, each of the plurality of question templates is randomly paired with at least one product in a product catalog. At operation 1306, each feature placeholder in the plurality of question templates is replaced with one or more features of the at least one product. At operation 1308, the plurality of questions are generated based on the plurality of question templates with the replaced feature placeholders.

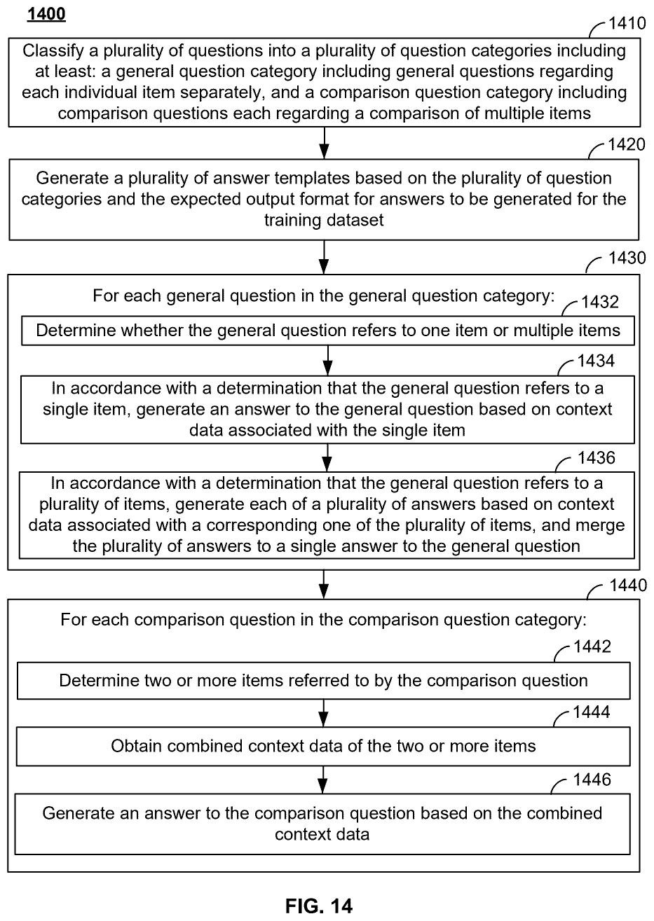

FIG. 14 shows a flowchart illustrating an example method 1400 for generating a plurality of answers to train a natural language model, in accordance with some embodiments. In some embodiments, the method 1400 can be performed as part of the operation 1106 of the example method 1100 in FIG. 11. In some embodiments, the method 1400 can be carried out by a system including one or more computing devices, such as the decision assistance computing device 102, the server 104, the conversational agent 109 and/or the cloud-based engine 121 of FIG. 1.

Beginning at operation 1410, a plurality of questions are classified into a plurality of question categories including at least: a general question category including general questions regarding each individual item separately, and a comparison question category including comparison questions each regarding a comparison of multiple items. At operation 1420, a plurality of answer templates are generated based on the plurality of question categories and the expected output format for answers to be generated for the training dataset.

The operation 1430 may include sub-operations 1432~1436 performed for each general question in the general question category. At sub-operation 1432, it is determined whether the general question refers to one item or multiple items. At sub-operation 1434, in accordance with a determination that the general question refers to a single item, an answer to the general question is generated based on context data associated with the single item. At sub-operation 1436, in accordance with a determination that the general question refers to a plurality of items, each of a plurality of answers is generated based on context data associated with a corresponding one of the plurality of items, and the plurality of answers are merged to a single answer to the general question.

The operation 1440 may include sub-operations 1442~1446 performed for each comparison question in the comparison question category. At sub-operation 1442, two or more items referred to by the comparison question are determined. At sub-operation 1444, combined context data of the two or more items are obtained. At sub-operation 1446, an answer to the comparison question is generated based on the combined context data.

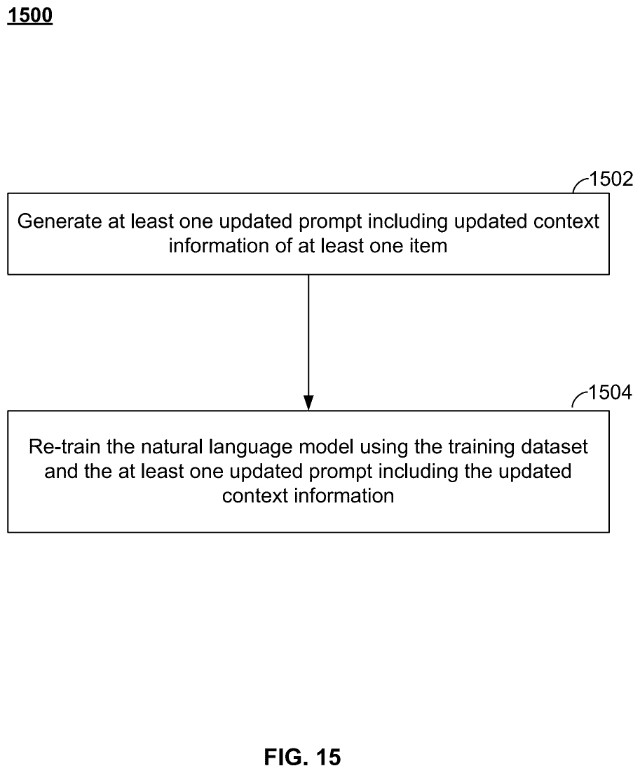

FIG. 15 shows a flowchart illustrating an example method 1500 for re-training a natural language model, in accordance with some embodiments. In some embodiments, the process 1500 can be carried out by a system including one or more computing devices, such as the decision assistance computing device 102, the server 104, the conversational agent 109 and/or the cloud-based engine 121 of FIG. 1. As shown in FIG. 15, the method 1500 starts from operation 1502, where at least one updated prompt is generated to include updated context information of at least one item. At operation 1504, the natural language model is re-trained using the training dataset and the at least one updated prompt including the updated context information.

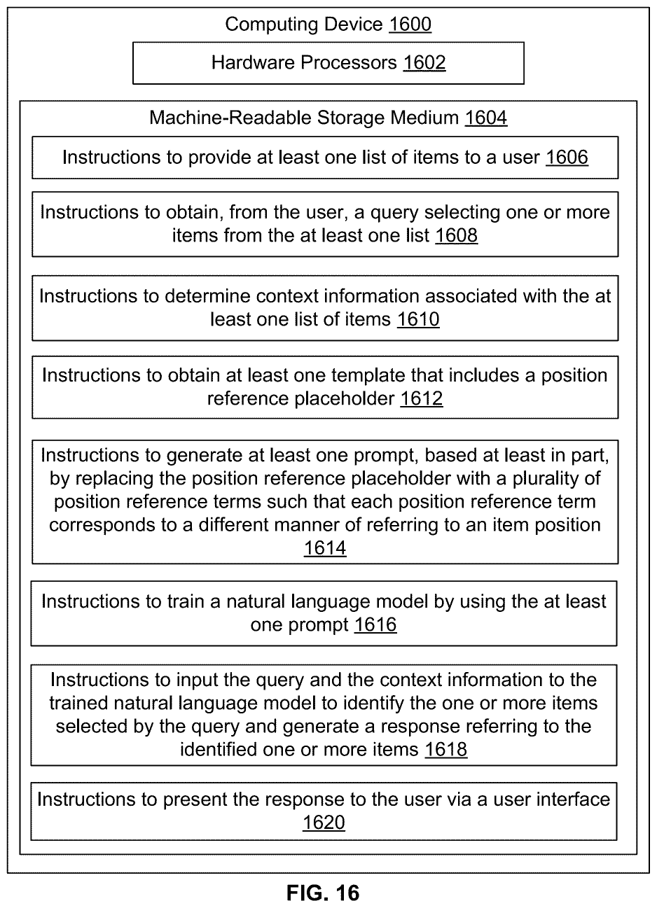

FIG. 16 depicts an example system 1600 (e.g. a computing device) for generating and presenting a response to a query, including a machine-readable medium 1604 encoded with example instructions executable by processing resource 1602, e.g. hardware processors, in accordance with some embodiments. In some implementations, the system 1600 may be useful for implementing aspects of the system 400 of FIG. 4. In some implementations, functionality described with respect to FIG. 4 may be included in the instructions encoded on machine-readable medium 1604.

The processing resource 1602 may include a microcontroller, a microprocessor, central processing unit core(s), an ASIC, an FPGA, and/or other hardware device suitable for retrieval and/or execution of instructions from the machine-readable medium 1604 to perform functions related to various examples. Additionally or alternatively, the processing resource 1602 may include or be coupled to electronic circuitry or dedicated logic for performing some or all of the functionality of the instructions described herein.

The machine-readable medium 1604 may be any medium suitable for storing executable instructions, such as RAM, ROM, EEPROM, flash memory, a hard disk drive, an optical disc, or the like. In some example implementations, the machine-readable medium 1604 may be a tangible, non-transitory medium. The machine-readable medium 1604 may be disposed within the system 1600 in which case the executable instructions may be deemed installed or embedded on the system. Alternatively, the machine-readable medium 1604 may be a portable (e.g., external) storage medium, and may be part of an installation package.

As described further herein below, the machine-readable medium 1604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 16.

The machine-readable medium 1604 includes instructions 1606-1616. Instructions 1606, when executed, cause the processing resource 1602 to provide at least one list of items to a user. The instructions 1608, when executed, cause the processing resource 1602 to obtain, from the user, a query selecting one or more items from the at least one list. The instructions 1610, when executed, cause the processing resource 1602 to determine context information associated with the at least one list of items. The instructions 1612, when executed, cause the processing resource 1602 to obtain at least one template that includes a position reference placeholder.

The instructions 1614, when executed, cause the processing resource 1602 to generate at least one prompt, based at least in part, by replacing the position reference placeholder with a plurality of position reference terms such that each position reference term corresponds to a different manner of referring to an item position. The instructions 1616, when executed, cause the processing resource 1602 to train a natural language model by using the at least one prompt. The instructions 1618, when executed, cause the processing resource 1602 to input the query and the context information to the trained natural language model to identify the one or more items selected by the query and generate a response referring to the identified one or more items. The instructions 1620, when executed, cause the processing resource 1602 to present the response to the user via a user interface.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
provide at least one list of items to a user,
obtain, from the user, a query selecting one or more items from the at least one list,
determine context information associated with the at least one list of items,
obtain at least one template that includes a position reference placeholder,
generate at least one prompt, based at least in part, by replacing the position reference placeholder with a plurality of position reference terms such that each position reference term corresponds to a different manner of referring to an item position,
train a natural language model by using the at least one prompt,
input the query and the context information to the trained natural language model to identify the one or more items selected by the query and generate a response referring to the identified one or more items, and
present the response to the user via a user interface.

2. The system of claim 1, wherein:
the context information is determined by converting recommendation related data into a standardized data format;
the recommendation related data comprises at least one of: an item identity of each item in the at least one list of items, position information of each item in the at least one list of items, or data displayed together with each item in the at least one list of items; and
the standardized data format is in accordance with a natural language acceptable by the trained natural language model.

3. The system of claim 1, wherein the natural language model is trained to:
determine a query type of the query, wherein the query type includes one of: a comparison of multiple items, a query involving a single item, or a query involving each of multiple items;
identify the one or more items based on the query type;
determine, from the context information, context data associated with the one or more items; and
generate the response based on: the query, the context data associated with the one or more items, and a conversation history between the user and a conversational agent using the trained natural language model.

4. The system of claim 3, wherein the response is generated, based at least in part, by:
generating a prompt including: the query, the context information, the conversation history and an instruction; and
inputting the prompt into the trained natural language model to generate the response, wherein:
each of the one or more items is referred to by the query using at least one of: a position of the item in the at least one list, an abbreviated item name of the item, a unique item identifier including price, brand or rating displayed together with the item in the at least one list,
the query is in form of a question regarding the one or more items,
the response includes: (1) an answer to the question and (2) at least one item indication indicating at least one item based on which the answer is generated, and
the answer refers to each of the at least one item using a corresponding item name.

5. The system of claim 1, wherein the natural language model is trained, based at least in part, by:
generating a plurality of prompts including context information of a plurality of items;
generating a plurality of questions;
generating a plurality of answers separately from the plurality of questions;
generating a training dataset based on the plurality of prompts, the plurality of questions and the plurality of answers; and
training the natural language model using the training dataset.

6. The system of claim 5, wherein generating the plurality of prompts comprises:
generating a plurality of prompt templates, wherein each of the plurality of prompt templates comprises the position reference placeholder and at least one of:
an assigned role of the natural language model,
a task instruction,
an unanswerable token placeholder,
a guideline for a response generation,
an expected output format for the response generation, or
one or more safety rules;
replacing each position reference placeholder in the plurality of prompt templates with a plurality of position reference terms corresponding to a plurality of manners of referring to an item position, wherein the plurality of position reference terms comprises at least: a numerical term, an ordinal term and a directional term;
replacing each unanswerable token placeholder in the plurality of prompt templates with one of: a predetermined token, a keyword, or an answer template;
adding at least one separator token to separate information for different items in each prompt template; and
generating the plurality of prompts based on the plurality of prompt templates with the replaced placeholders and the added at least one separator token.

7. The system of claim 6, wherein generating the plurality of questions comprises:
generating a plurality of question templates based on the plurality of prompts governed by at least one rule that restricts types of questions to be generated for the training dataset, wherein each of the plurality of question templates comprises at least one feature placeholder for product related features including at least: product information, seller information, and transaction-related information;
randomly pairing each of the plurality of question templates with at least one product in a product catalog;
replacing each feature placeholder in the plurality of question templates with one or more features of the at least one product; and
generating the plurality of questions based on the plurality of question templates with the replaced feature placeholders.

8. The system of claim 7, wherein generating the plurality of answers comprises:
classifying the plurality of questions into a plurality of question categories including at least: a general question category including general questions regarding each individual item separately, and a comparison question category including comparison questions each regarding a comparison of multiple items;
generating a plurality of answer templates based on the plurality of question categories and the expected output format for answers to be generated for the training dataset;
for each general question in the general question category:
determining whether the general question refers to one item or multiple items,
in accordance with a determination that the general question refers to a single item, generating an answer to the general question based on context data associated with the single item, and
in accordance with a determination that the general question refers to a plurality of items, generating a plurality of answers, each of which is generated based on context data associated with a corresponding one of the plurality of items, and merging the plurality of answers to a single answer to the general question; and
for each comparison question in the comparison question category:
determining two or more items referred to by the comparison question,
obtaining combined context data of the two or more items, and
generating an answer to the comparison question based on the combined context data.

9. The system of claim 5, wherein the natural language model is re-trained, based at least in part, by:
generating at least one updated prompt including updated context information of at least one item; and
re-training the natural language model using the training dataset and the at least one updated prompt including the updated context information.

10. A computer-implemented method, comprising:
providing at least one list of items to a user;
obtaining, from the user, a query selecting one or more items from the at least one list;
determining context information associated with the at least one list of items;
obtaining at least one template that includes a position reference placeholder;
generating at least one prompt, based at least in part, by replacing the position reference placeholder with a plurality of position reference terms such that each position reference term corresponds to a different manner of referring to an item position;
training a natural language model by using the at least one prompt;
inputting the query and the context information to the trained natural language model to identify the one or more items selected by the query and generate a response referring to the identified one or more items; and
presenting the response to the user via a user interface.

11. The computer-implemented method of claim 10, wherein:
the context information is determined by converting recommendation related data into a standardized data format;
the recommendation related data comprises at least one of: an item identity of each item in the at least one list of items, position information of each item in the at least one list of items, or data displayed together with each item in the at least one list of items; and
the standardized data format is in accordance with a natural language acceptable by the trained natural language model.

12. The computer-implemented method of claim 10, wherein the natural language model is trained to:
determine a query type of the query, wherein the query type includes one of: a comparison of multiple items, a query involving a single item, or a query involving each of multiple items;
identify the one or more items based on the query type;
determine, from the context information, context data associated with the one or more items; and
generate the response based on: the query, the context data associated with the one or more items, and a conversation history between the user and a conversational agent using the trained natural language model.

13. The computer-implemented method of claim 12, wherein the response is generated, based at least in part, by:
generating a prompt including: the query, the context information, the conversation history and an instruction; and
inputting the prompt into the trained natural language model to generate the response, wherein:
each of the one or more items is referred to by the query using at least one of: a position of the item in the at least one list, an abbreviated item name of the item, a unique item identifier including price, brand or rating displayed together with the item in the at least one list,
the query is in form of a question regarding the one or more items,
the response includes: (1) an answer to the question and (2) at least one item indication indicating at least one item based on which the answer is generated, and
the answer refers to each of the at least one item using a corresponding item name.

14. The computer-implemented method of claim 10, wherein training the natural language model comprises:
generating a plurality of prompts including context information of a plurality of items;
generating a plurality of questions;
generating a plurality of answers separately from the plurality of questions;
generating a training dataset based on the plurality of prompts, the plurality of questions and the plurality of answers; and
training the natural language model using the training dataset.

15. The computer-implemented method of claim 14, wherein generating the plurality of prompts comprises:
generating a plurality of prompt templates, wherein each of the plurality of prompt templates comprises the position reference placeholder and at least one of:
an assigned role of the natural language model,
a task instruction,
an unanswerable token placeholder,
a guideline for a response generation,
an expected output format for the response generation, or
one or more safety rules;
replacing each position reference placeholder in the plurality of prompt templates with a plurality of position reference terms corresponding to a plurality of manners of referring to an item position, wherein the plurality of position reference terms comprises at least: a numerical term, an ordinal term and a directional term;
replacing each unanswerable token placeholder in the plurality of prompt templates with one of: a predetermined token, a keyword, or an answer template;
adding at least one separator token to separate information for different items in each prompt template; and
generating the plurality of prompts based on the plurality of prompt templates with the replaced placeholders and the added at least one separator token.

16. The computer-implemented method of claim 15, wherein generating the plurality of questions comprises:
generating a plurality of question templates based on the plurality of prompts governed by at least one rule that restricts types of questions to be generated for the training dataset, wherein each of the plurality of question templates comprises at least one feature placeholder for product related features including at least: product information, seller information, and transaction-related information;
randomly pairing each of the plurality of question templates with at least one product in a product catalog;
replacing each feature placeholder in the plurality of question templates with one or more features of the at least one product; and
generating the plurality of questions based on the plurality of question templates with the replaced feature placeholders.

17. The computer-implemented method of claim 16, wherein generating the plurality of answers comprises:
classifying the plurality of questions into a plurality of question categories including at least: a general question category including general questions regarding each individual item separately, and a comparison question category including comparison questions each regarding a comparison of multiple items;
generating a plurality of answer templates based on the plurality of question categories and the expected output format for answers to be generated for the training dataset;
for each general question in the general question category:
determining whether the general question refers to one item or multiple items,
in accordance with a determination that the general question refers to a single item, generating an answer to the general question based on context data associated with the single item, and
in accordance with a determination that the general question refers to a plurality of items, generating a plurality of answers, each of which is generated based on context data associated with a corresponding one of the plurality of items, and merging the plurality of answers to a single answer to the general question; and
for each comparison question in the comparison question category:
determining two or more items referred to by the comparison question,
obtaining combined context data of the two or more items, and
generating an answer to the comparison question based on the combined context data.

18. The computer-implemented method of claim 14, further comprising re-training the natural language model, based at least in part, by:
generating at least one updated prompt including updated context information of at least one item; and
re-training the natural language model using the training dataset and the at least one updated prompt including the updated context information.

19. A non-transitory computer readable medium having instructions stored thereon, wherein the instructions, when executed by at least one processor, cause at least one device to perform operations comprising:
providing at least one list of items to a user;
obtaining, from the user, a query selecting one or more items from the at least one list;
determining context information associated with the at least one list of items;
obtaining at least one template that includes a position reference placeholder;
generating at least one prompt, based at least in part, by replacing the position reference placeholder with a plurality of position reference terms such that each position reference term corresponds to a different manner of referring to an item position;
training a natural language model by using the at least one prompt;
inputting the query and the context information to the trained natural language model to identify the one or more items selected by the query and generate a response referring to the identified one or more items; and
presenting the response to the user via a user interface.

20. The non-transitory computer readable medium of claim 19, wherein the natural language model is trained to:
determine a query type of the query, wherein the query type includes one of: a comparison of multiple items, a query involving a single item, or a query involving each of multiple items;
identify the one or more items based on the query type;
determine, from the context information, context data associated with the one or more items; and
generate the response based on: the query, the context data associated with the one or more items, and a conversation history between the user and a conversational agent using the trained natural language model.
